(19) United States
(12) Patent Application Publication
(10) Pub. No.: US 2002/0131401 A1
(43) Pub. Date: Sep. 19, 2002

(54) Sharing remote terminals

(76) Inventor: David Ehreth, Santa Rosa, CA (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 09/809,338

(22) Filed: Mar. 14, 2001

(51) Int. Cl. H04L 12/66

(52) U.S. Cl. 370/352; 370/395.1

(57) ABSTRACT

A method for sharing a remote terminal. The method provides control intelligence that is separate from service-delivery hardware of a network that includes a remote terminal, wherein the control intelligence controls the operations of the remote terminal. The method time-shares resources of the remote terminal among local exchange carriers, wherein the control intelligence mediates access to the remote terminal, and whereby multiple local exchange carriers provide telecommunication services on the remote terminal.

### BACKGROUND

This invention relates to telecommunication.

In the last decade, large numbers of Next Generation Digital Loop Carriers (NGDLC) were deployed throughout the country. NGDLCs are part of a larger plan to deliver voice services with a high degree of efficiency and economy. An NGDLC acts as an “extension cord” for a Class 5 central office voice switch. An NGDLC can multiplex up to 2,000 voice paths on a fiber optic connection, providing cost and reliability benefits.

A conventional NGDLC has two terminals, one located in a central office and one located in a remote location near a community of users. NGDLCs can be configured in rings or in chains. The remote terminal of an NGDLC includes a number of circuit cards that are connected to end user devices such as telephones and private branch exchanges (PBXs). The remote terminal can be “hardened,” able to operate in harsh environments of heat, cold and humidity. The remote terminal can be located on street corners, sidewalks, telephone poles or in remote “huts” near end users.

An important protocol was developed in the late 1980s and early 1990s that facilitated the use of NGDLCs. This protocol, today known as GR-303, is used to connect an NGDLC to a Class 5 switch. To gain even greater economies, a technique known as “concentration” is used in the GR-303 protocol. Concentration is a technique that enables a large number of telephone users to employ a smaller number of trunk paths to a Class 5 switch. Usually, not everyone will use his or her telephone at the same time. By taking advantage of this fact, a reduction in the trunk size of a Class 5 switch could be realized. For example, as few as 400 trunk paths to the switch could serve 2,000 telephones without any noticeable degradation in the quality of service.

Concentration requires a primitive level of switching. In a conventional telecommunication system, the Class 5 switch that is connected to an NGDLC controls the switching (concentration) function at the NGDLC through a control link defined in the GR-303 protocol.

The GR-303-based NGDLC can host multiple GR-303 “virtual” groups inside of a single physical platform. This capability is particularly useful for load balancing traffic in order to achieve an optimum concentration ratio. Each virtual GR-303 group requires a data link for control, a Time Slot Management Channel (TMC), and a provisioning link known as an Embedded Operations Channel (EOC). System provisioning commands pass through the EOC and allow the NGDLC to be configured by Operations Support Systems (OSS) that interface to a Class 5 switch.

During the decade of the 1990's when NGDLCs were being installed, the rapid growth of the Internet created a new demand for data services. Network operators who owned NGDLCs saw an opportunity to use these platforms as delivery vehicles for advanced services such as data communications. As a result, most of the NGDLC vendors configured their products to handle one or more data protocols. Further, the NGDLCs were designed or enhanced to offer digital subscriber line services or fiber optic services.

In 1996, the Telecommunications Reform Act (TR-96) opened the local service market to competition. Competitive Local Exchange Carriers (CLEC) were allowed to sell services over “unbundled” facilities. In the case of copper wire facilities, the process is fairly straightforward. A CLEC sells a service to a customer, notifies the Incumbent Local Exchange Carrier (ILEC) that he has made the sale, and the ILEC is required to locate the copper wire that serves that customer and deliver it to the CLEC at a central office. This simple process becomes somewhat more complicated when the customer is served from an NGDLC over what is called an electronically-derived loop, such as a connection provided through an NGDLC.

As part of the opening of competition in the communications markets, Congress and the FCC have ruled that ILECs who have in the past been beneficiaries of local telephone monopolies may not, themselves, provide data communications services. However, ILECs have been allowed to operate unregulated subsidiary businesses that may provide data services. Meanwhile, a large number of CLECs and Data Local Exchange Carriers (DLEC) have begun to offer data services.

Because there has been no general clarification on the issue of unbundling electronically-derived loops and because the ILEC operators have been restricted from providing data services, remote terminals of NGDLCs have not been extensively used for delivery of data services. This is unfortunate for two reasons. First, NGDLCs are the ideal location to launch data services because they are located a short distance from end users. Second, there are alternatives to unbundling remote terminal facilities that, while fair to CLECs, allow ILEC owners to retain a significant ability to provide all network service providers, subsidiaries and CLECs alike, with high value services.

The GR-303 protocol appears to provide a good solution for unbundling services from an NGDLC remote terminal (RT). Virtual GR-303 groups could be created for each CLEC that wanted to have virtual access to the RT. These groups are defined in the GR-303 standard as “Interface Groups.” Each interface group is logically portioned so that it behaves as a separate resource. These groups could be delivered to the CLEC point of presence (POP) in the ILEC central office near the central office terminal (COT) of the NGDLC. Each CLEC could then transport its GR-303 group along with TMC and EOC to its remote switch center where it would connect to its own Class 5 switch. This approach would seem to give the CLEC the ability to control both feature offerings and switch resources. However, on closer examination, the GR-303 protocol presents some significant challenges when used as a multi-tenant solution for unbundling.

There are two major problems with using GR-303 as an unbundling tool. First, GR-303 is not scalable for unbundling. Second, problems with shared databases used in GR-303 can cause catastrophic system failures.

The original intent of interface groups was to perform a function known as “load balancing.” High-traffic customers can potentially upset the concentration ratio between line resources and trunk resources because the GR-303 protocol is a concentrating interface. A high-traffic user can congest a system that has allocated one trunk resource to every four-line appearances. To solve this potential problem and to get the best economics from concentration, GR-303 allows multiple interface groups to be created on a single RT. Accordingly, a network operator can virtually gather his high-traffic users together on a single interface group with a low concentration ratio, such as 2:1, while leaving the low-traffic users (usually the majority) on high concentration ratio interface groups, such as 4:1. GR-303 allows for a maximum of eight interface groups. Popular digital loop carrier systems, such as the Alcatel Litespan 2000 and the Advanced Fibre Communications UMC 1000, allow for 4 and 6 interface groups per RT, respectively.

Each interface group uses a redundant TMC. Each TMC occupies one 64 Kb/s channel in a T1 trunk. The GR-303 TMC uses the ISDN call processing protocol Q.931 to perform concentration on the remote terminal. However, as a means of unbundling a remote terminal, the use of individual protocol stacks for each interface group presents a problem. Specifically, the GR-303 architecture is not scalable beyond certain practical limits. There are several reasons for this.

First, the amount of computing resources to manage the Q.931 resource is not infinitely expandable within a given RT. The second reason is that both of the two TMCs on each interface group require a physical link to terminate the High-Level Data Link Protocol (HDLC) used as the link-layer transport methodology. Each HDLC termination requires an allocation of physical space, which reaches certain practical limits within the constraints of the RT and the COT. As shown in FIG. 5a, if a COT, such as COT 524, were to service a chain of four remote terminals (RTs) 503 and each of these terminals was equipped with four interface groups (represented by broken lines and numbered 1 through 16), COT 524 would be required to manage 16 active and 16 stand-by data links to support 16 different service providers.

However, as shown if FIG. 5b, if a provider had subscribers on all of the RTs (represented by bold, solid lines), such demand would consume four of the 16 interface groups on COT 524, leaving only 12 interface groups for other providers.

As shown in FIG. 5c, if a second provider (e.g., CLEC-A) also had subscribers on all of the RTs (represented by bold, broken lines), the second provider would consume four more interface groups on COT 524 as well. That would leave only eight interface groups. If CLEC-B and DLEC-1 have subscribers on all the RTs, these four providers would consume all 32 data links.

If there were subscribers to a fifth service provider, these stranded subscribers could only be made available on a “universal interface.” A universal interface has a 1:1 mapping or connection between a subscriber terminal and a trunk circuit in an “always connected” mode. This universal interface defeats the purpose of GR-303, which is to eliminate the high cost and low efficiency of the universal mode.

Having GR-303 interfaces available to a small number of network operators and a universal interface available to other operators would create a fundamentally unbalanced cost system for RT unbundling. On the other hand, forcing everyone to the universal interface would mark a significant regression in terms of cost and architecture.

Another issue with the use of multiple GR-303 interface groups for the purpose of RT unbundling is the general database architecture of GR-303. FIG. 6 shows the basic master/slave relationship between a local digital switch (LDS) 602 and an NGDLC 604, where the LDS is the master and the NGDLC is the slave.

FIG. 7 shows an RT 702 that has been unbundled and is a slave to many switches 704. It must be presumed that one of these switches is the database master and that the other switches are database slaves.

The master/slave relationship in the GR-303 architecture provides a very efficient method for the LDS to control the resources of the NGDLC. GR-303 was created with the assumption that, while there may be several interface groups, there would be only one network operator and only one provisioning system. Thus, the LDS could be certain that it knows what resources exist within an RT. Also, the LDS can manage the different interface groups created by a single provisioning system, each with its own database. If there were an error in the provisioning (for example, one interface group claimed resources within another interface group), a significant malfunction would occur. This malfunction could include symptoms as minor as the loss of a call to the loss of an entire interface group. It is possible for a system to be brought down by such a database error. Because of this, a great deal of caution is used when building system databases. Even when in use, a system of database “auditors” runs in the background to crosscheck the integrity of the databases. Database integrity is one of the most complex elements of system design for a GR-303 system. Failure of database integrity can cause catastrophic results.

The GR-303 protocol's inability to scale and its vulnerability to catastrophic failure caused by sharing critical databases between master and slave switches indicate that the GR-303 protocol is not configured to solve the unbundling problem.

### SUMMARY

In general, in one aspect, the invention provides a method for sharing a remote terminal. The method provides control intelligence that is separate from service-delivery hardware of a network that includes a remote terminal, wherein the control intelligence controls the operations of the remote terminal. The method time-shares resources of the remote terminal among local exchange carriers, wherein the control intelligence mediates access to the remote terminal, and whereby multiple local exchange carriers provide telecommunication services on the remote terminal.

In general, in another aspect, the invention provides a system for sharing remote terminals. The system includes control intelligence to control a remote terminal in a telecommunication network that has service-delivery hardware. The control intelligence mediates access to the remote terminal and is separate from the service-delivery hardware. The system includes databases that are separate from service-delivery hardware of the network to guide the delivery of telecommunication features. The databases relate a subscriber and the subscriber's respective local exchange carrier, as well as local exchange carriers and telecommunication features offered by each local exchange carrier. The control intelligence causes the delivery of telecommunications features to the subscribers according to the databases.

The invention can be implemented to realize one or more of the following advantages. An access switch approach for egalitarian unbundling is provided that scales to an unlimited number of owner operators and eliminates database synchronization issues raised by GR-303. A uniform call feature delivery system is provided. A nearly unlimited number of service providers can virtually own resources of a single RT. These virtual owners can provide their own services and features, independent of other owners. Current operators can continue business uninterrupted while new operators gain access to existing RTs. Dial tone is provided at a fraction of the cost of traditional Class 5 alternatives. To implement the access approach for unbundling, there is no need to make complicated physical arrangements in the network (such as space sharing, etc.). Additionally, implementation requires a minimum modification of existing network facilities that can be accomplished quickly. New operators have the ability to provide services and features of their choosing because access switching separates the control intelligence from the physical service delivery layer of the network. This independence allows services to continue to evolve on the same physical platform without having to change the actual hardware. The access switch provides this kind of capability to existing RTs, thus enabling new kinds of services to appear without having to change existing hardware. Physical system operators, such as ILECs, can sell value-added capabilities over and above basic unbundled loops while allowing new competitors, such as CLECs, to provide services to customers through the same loops. Problems associated with loop testing in a multi-owner electronic-loop environment are eliminated. Access switching unbundles RTs while preserving their fundamental physical architecture and leveraging some of their latent capabilities. Access switching positions the network for continued evolution to advanced services while not disadvantaging any single network service provider.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a general architecture of an access-switched network.

FIG. 2 shows an implementation of an access-switched approach to unbundling.

FIG. 3 shows a network implementing an access-switch approach for unbundling DSL in RTs.

FIG. 4 shows a network implementing an access-switch approach for unbundling POTS.

FIG. 5a shows a network used by a single provider.

FIG. 5b shows a network where a single provider has subscribers on all of the RTs.

FIG. 5c shows a network where two providers have subscribers on all the RTs.

FIG. 6 shows a GR-303 Master/Slave architecture.

FIG. 7 shows an unbundled RT that is a slave to multiple switches.

FIG. 8 shows a method of providing a feature to a subscriber through a shared remote terminal in accordance with the invention.

FIG. 9 shows a network implementing an access-switch approach for unbundling call features.

FIG. 10 shows a network implementing an access-switch approach for ATM proxy signaling.

Like reference symbols in the various drawings indicate like elements.

### DETAILED DESCRIPTION

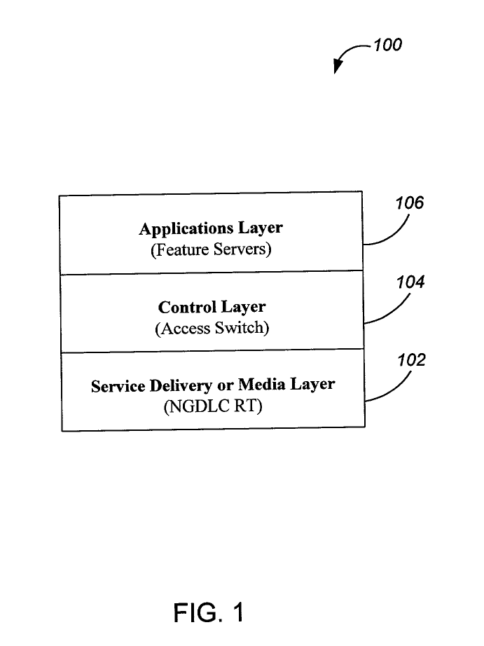

A system including access switching is provided for unbundling RTs. FIG. 1 shows an access-switched network 100. In the access switched architecture, the actual physical connections to end-users are made at the RT as done today by ILECs. This layer of the architecture, a service delivery or media layer 102, is in place today and carries the actual “bearer” traffic.

Control of the service delivery or media layer is accomplished at a control layer 104 by an access switch (i.e., a call control agent). The access switch is a body of software running on a dedicated computer that provides control and signaling to the service delivery device, typically a switching device such as a next-generation-digital-loop-carrier remote terminal (NGDLC RT). The access switch further includes a database that enables virtual subdivision of the physical RT resources. To communicate with the RTs, the access switch is physically attached to the switching hardware of the RTs that it controls by control data links (not shown). Predetermined messages are sent between the call control agent and the switching hardware to notify the call agent of events occurring at the switching hardware and to allow the call control agent to control the operations of the switching hardware. For example, when a telephone is taken off its hook, the switching hardware signals the call agent that an off-hook condition has been detected. Then, the call agent instructs the switching hardware to provide dial tone to the caller and assigns the caller to a tone decoder to receive the dialed digits. Once received, the switching hardware sends the dialed digits to the call agent who then determines where the call should be routed. Then, the call agent instructs the switching hardware to make the proper connections. Thus, an access switch enables switching and routing to be done at the NGDLC RT.

An access switch, in turn, interfaces with an applications layer 106. An applications layer includes devices referred to as feature servers. The feature servers are similar to an access switch in that they are bodies of software that run on dedicated computers. Feature servers provide the telecommunication applications and features for end-users who are connected to a service delivery layer. Common examples of features are call waiting, call forwarding, and three-party calling. Network operators sell these features to network subscribers. The features are provided from separate software modules that usually operate from different computers located in the telephone network. The feature server can deliver features to a subscriber in a variety of means. The feature server and the call agent can be connected by a serial port or can be co-located and run on the same computer. If the feature server is located at a distance from the call control agent, a connection methodology such as internet protocol (IP) can be used as the lower layer for carrying the API. When an IP network is used to connect feature servers to call control agents, an arbitrary number of feature servers can be connected to a single call agent. Similarly, a single feature server can be connected to an arbitrary number of call agents. To determine when and how to contact one of many feature servers when responding to a subscriber's request for feature service, a call control agent consults a database which specifies the available service-delivery resources, the feature providers (or feature owner) for the subscriber, and the features offered by the feature provider.

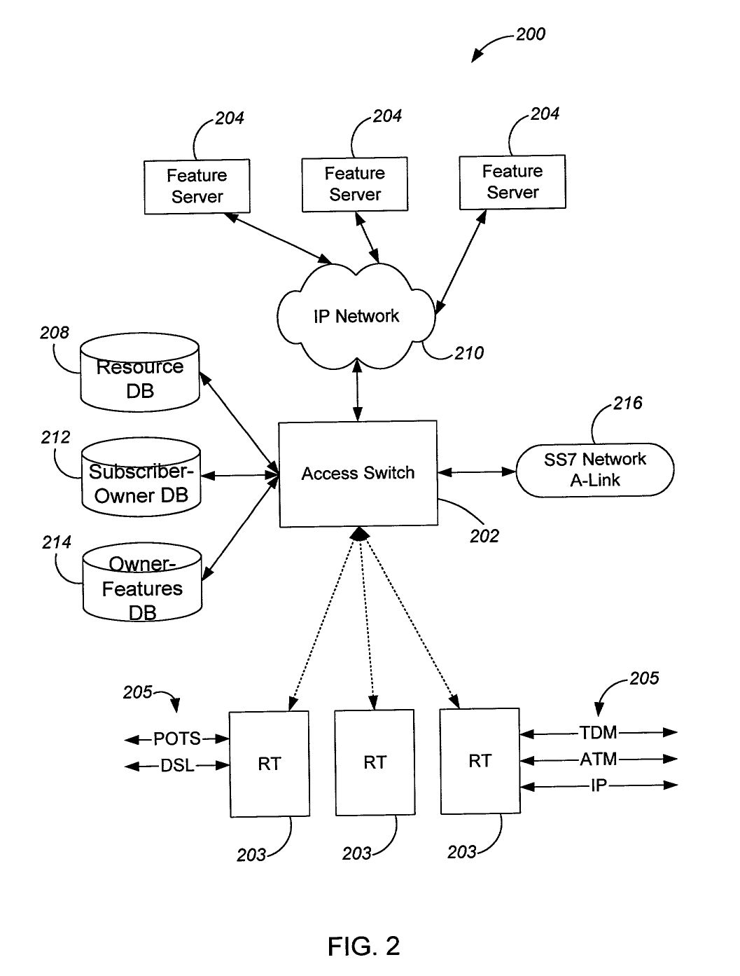

FIG. 2 shows a system 200 implementing access switching. A single access switch 202 controls many service delivery devices such as RTs 203. In one implementation, a single access switch, such as access switch 202, can control up to 100,000 subscribers connected to many RTs. Access switch 202 is connected to multiple feature servers 204. Each single feature server 204 can be simultaneously connected to many other access switches 202. Access switch 202 creates dial tone, performs call processing and network signaling for voice traffic, and performs connection control and signaling for packet-based traffic. Access switch 202 includes resource database 208 that includes an image of the physical system and tracks system resources. When processing calls or connections, access switch 202 accesses resource database 208 to determine resources available and virtual owners to whom resources have been assigned.

Feature servers 204 interconnect to access switch 202 over a packet network, such as IP network 210. Access switch 202 performs control functions but has no internal ability to provide features. When a subscriber invokes a feature, either by a sequence of keys or by generating a data message, access switch 202 consults a subscriber-owner database 212 to determine which virtual owner is associated with the subscriber. Once the owner is identified, access switch 202 accesses an owner-feature database 214 that includes the virtual owner's “feature table.” A feature table correlates subscriber keystrokes or messages to feature servers 204 where feature software is physically located. A virtual owner configures the feature table according to its business interests. A feature table provides access switch 202 with the address of a virtual operator's feature server 204. Access switch 202 contacts the feature server 204 and executes the feature server's directions such as give tone, collect digits, set up a session, and provides any other features required. When a feature sequence is complete, call control returns to access switch 202. Because they are connected over a packet network, such as packet network 210, there is no limit to the number of feature servers 204 that can provide features to the access switch 202 and to subscribers.

As described above, feature servers 204 can be connected to multiple access switches 202. The number of connections may depend on how much feature traffic their computer can handle at any one time. Feature servers 204 can use any of several protocols to communicate with access switches 202, and rely on packet networks to carry instructions back and forth between the feature server 204 and the access switch 202. A network operator can connect a single feature server 204 to unbundled RTs and, at the same time, use the feature server with co-located access devices. The co-located access device can be used by CLECs to electronically gather unbundled loops inside an ILEC wire center.

The service delivery or media layer of the network, the NGDLC RT, is a widely deployed technology. Most NGDLCs have powerful, latent capabilities that enable them to perform voice switching and ATM routing. Many are able to serve a plethora of services ranging from POTS to DSL. Most RTs can be upgraded easily to manage DSL and ATM. Upgrading an NGDLC RT to work with an access switch only requires additional hardware for decoding tone dialing and for generating tones. Most of the work required to upgrade an NGDLC to work with an access switch is at the COT where trunk groups are formed. For example, a digit additional to the numbering plan area (NPA, which is commonly called an area code) and the local exchange code are needed to enable a class 4 switch to recognize trunk groups having less than 10,000 subscribers. This change can be implemented at the COT by upgrading the COT's tone decoders.

Access switch 202 provides network signaling for both voice traffic and data traffic. When handling voice traffic, access switch 202 provides a convenient aggregation point for the Signaling System 7 Network (SS7). One SS7 A-Link 216 connected to access switch 202 will service a widely distributed group of RTs 203.

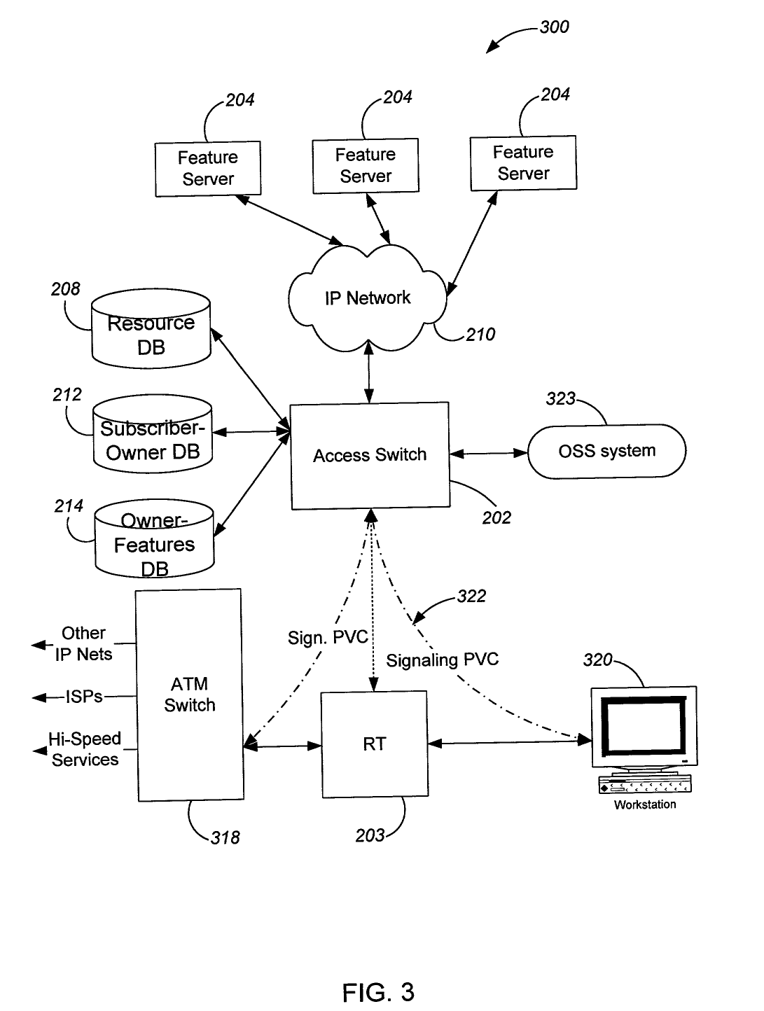

As shown in FIG. 3, when providing DSL services from RT 203 to subscribers, such as subscriber 320, access switch 202 serves as a “proxy-signaling agent.” Usually, DSL configurations rely upon ATM transport through an ATM switch 318. Access switch 202 can serve as an ATM proxy-signaling agent. Proxy signaling uses ATM Forum UNI 4.0 signaling between subscriber terminals and a proxy-signaling agent in access switch 202. When subscriber 320 signals for a connection, a call agent in access switch 202 works with a feature server 204 of the subscriber's virtual owner to find the service. Once the network location for the service has been determined, the call agent acts as an ATM proxy-signaling agent to establish the virtual connection. A DSL service provider can have virtual ownership at RT 203 and be switched, giving DSL a level of scalability that it does not have when using permanent virtual circuits (PVC), such as PVC 322.

When DSL is used to provide voice over DSL (VoDSL), access switch 202 manages calls either as ATM connections or as TDM connections. In either case, access switch 202 provides capability to manage a subscriber end of the call as ATM or TDM and the trunk side of the call as TDM, ATM, or IP. In each case, a virtual owner determines the trunk protocol on a call-by-call basis, depending on services selected by a subscriber using a feature server 204.

Access switch 202 can control all or part of RT 203. If RT 203 is connected to a Class 5 switch over TR-08 or GR-303, that connection can remain while other parts of the RT can be controlled by access switch 202. Thus, RT 203 can be unbundled progressively without disturbing the configuration of the original owner or operator.

Referring to FIG. 2, inter-machine trunks (IMT) 205, e.g., ATM, TDM, and IP trunks, connect the time division multiplexed (TDM) voice traffic coming from an NGDLC to a network. IMTs 205 are the traditional trunk type that connects Class 5 switches to a network. These trunks can be segregated by ownership or can carry mixed traffic. IMTs 205 can be connected directly to Class 4 Tandem switches or pre-sorted and aggregated through cross connects. Other trunks using this same general architecture can carry packetized data, including packetized voice data.

Optical connections (not shown) are available to carry high-speed data traffic from the NGDLC into the network. These connections can be engineered to meet the needs of the services that they carry such as asynchronous transfer mode (ATM), Internet protocol (IP), or others.

Access switch 202 is not dedicated to a particular type of connection management or switching because access switch 202 is separated from the network service delivery hardware. Rather, access switch 202 readily adapts to new network protocols. Thus, access switch 202 can be useful to voice switching, and at the same time, can manage switched virtual circuits (SVCs) for ATM including packetized voice data.

Unbundling RTs involves unbundling both POTS and digital services such as DSL. An access-switching architecture addresses both of these classes of service. FIG. 3 shows an example of network 300 for unbundling DSL circuits in RT 203. As discussed above, ownership of the physical platform, RT 203, remains intact. Virtual division of the RT facility is aided by the use of an external OSS system, such as OSS system 323, that can receive orders for circuits from many CLECs and translate those orders into specific provisioning commands for configuring databases 208, 212, and 214 of access switch 202. Having only one set of databases for each switch eliminates any database synchronization problem.

Each DSL circuit can be switched according to service needs because, as discussed above, the configuration shown in FIG. 3 is inherently capable of proxy signaling. Thus, DSL connections using ATM transport are scalable. Use of PVCs, such as PVC 322, strands large amounts of bandwidth because there is no way to turn a connection off and on. Proxy signaling solves this problem. When implemented in an access switch architecture, proxy signaling solves the problem of creating scalable virtual ownership. Each DSL circuit in RT 203 can be assigned to a different virtual owner. No special data links are required to add virtual owners.

Note that the configuration shown in FIG. 3 above is not limited to ATM signaling. Other protocols can also be used to achieve the same results.

The same general criteria that apply to DSL also apply to POTS. Each circuit in RT 203 can be virtually owned. The individual circuits can then be associated with a feature server 204 of a virtual owner. Switching of POTS circuits can result either in circuits being terminated on the RT 203 for inter-RT calls, or on circuits terminated on an IMT towards the network. SS7 signaling is performed on behalf of the distributed system by access switch 202.

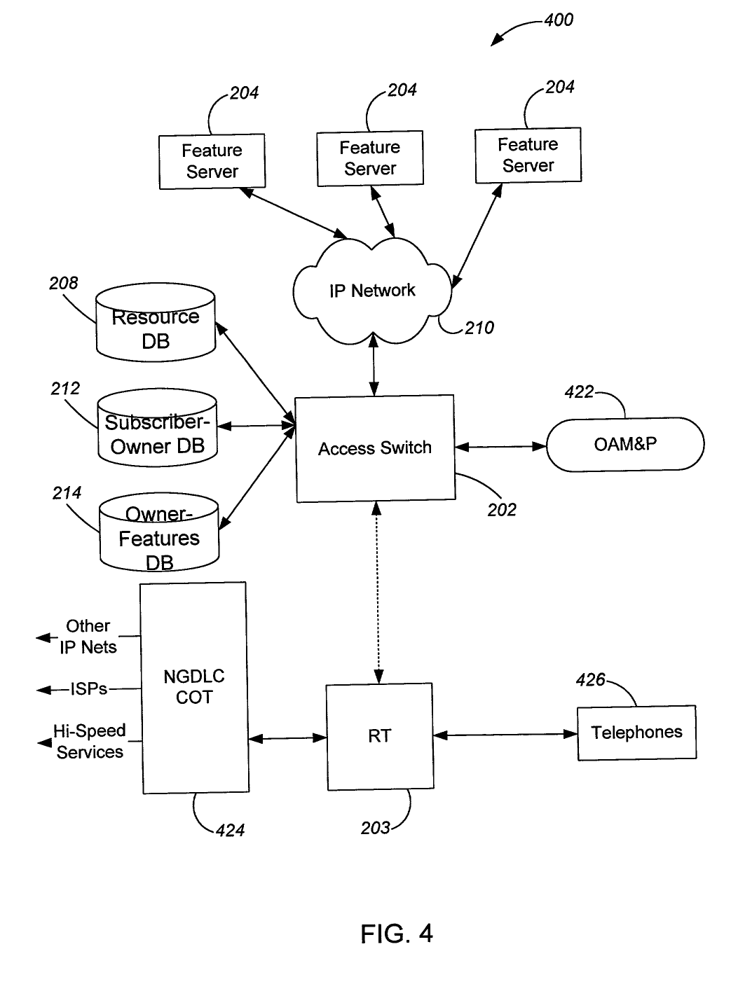

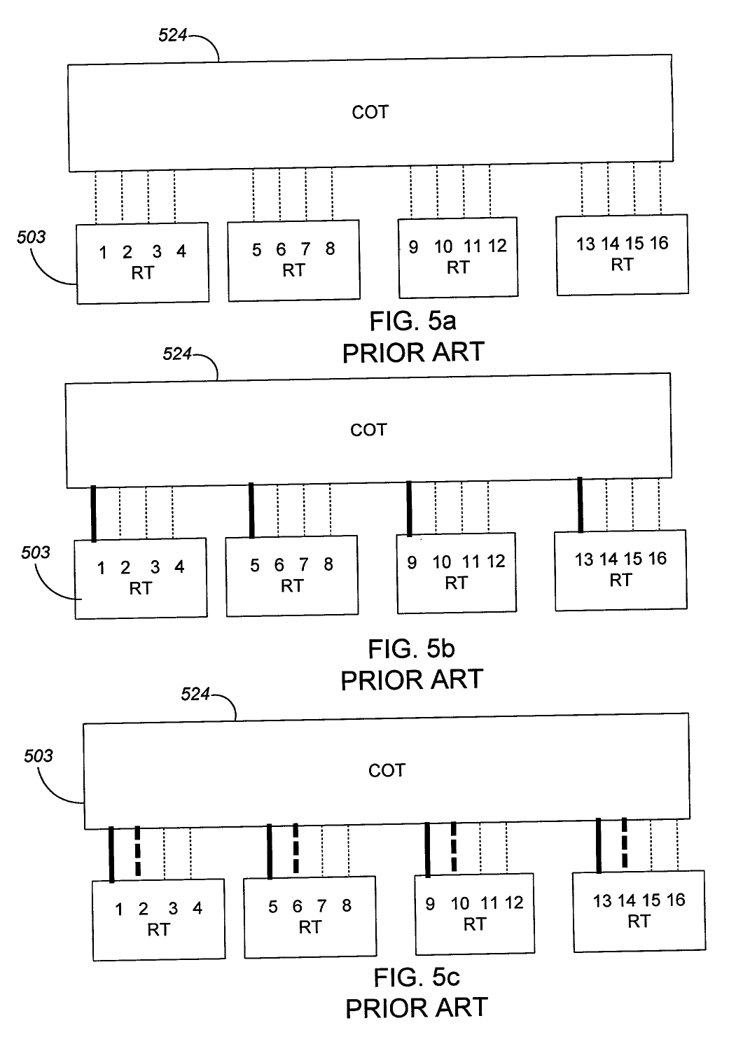

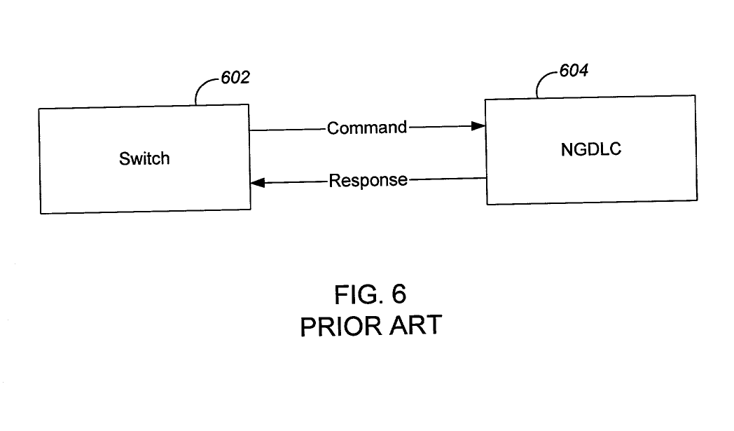

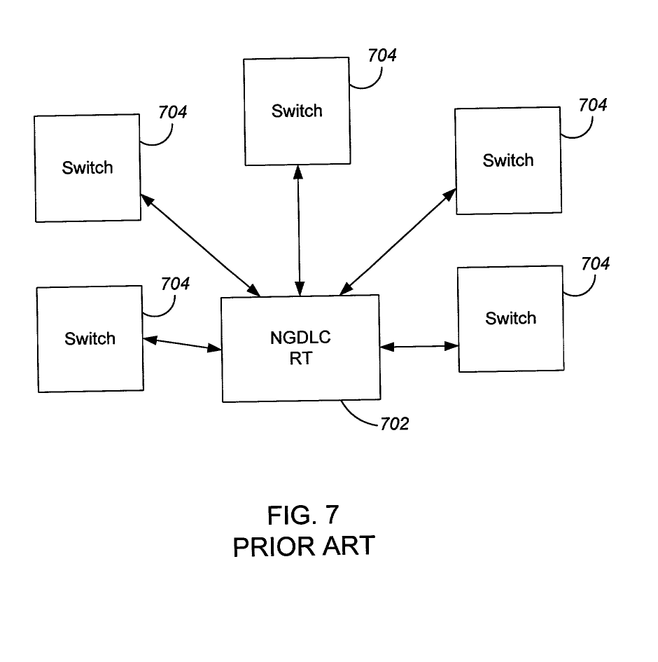

FIG. 4 shows access switched architecture 400 required to unbundle POTS circuits in RT 203 that provides call service to customer telephones 426. In this mode, RT 203 can use the access switch 202 to perform the proxy signaling for DSL described in the previous section while processing voice calls from an NGDLC, such as COT 424, on behalf of many virtual owners. The assumption in this configuration is that there is a single physical owner of RT 203 and access switch 202. The operator of these facilities employs a multi-client provisioning system that enables work orders to be processed through the physical system operator.

The feature tables that are used to correlate feature invocation to feature servers 204 can be built through the multi-client OAM&P system 422 at the time that the virtual owner initiates call service on RT 203. Feature servers 204 connect to access switch 202 through IP network 210. Feature tables (not shown), such as those resident on databases 212 and 214, include a template form that can be easily downloaded. In one implementation, feature tables are small data structures making the number of feature tables present at any one time practically unlimited. Feature tables can be modified without affecting operation of any other service provider and contain dialing plans for initiating a feature. Corresponding to any feature entry is a network address of the feature server that provides the service. Access switch 202, depending on which feature server-to-access switch protocol is being used, supplies necessary information to feature server 204 so that feature server 204 can take control of a call during a feature sequence.

Access switch 202 provides to feature 204 all of the usual information regarding traffic, call peg counts, status and alarm information. It is a relatively easy matter to sort this information by owner so that each owner has access to information expected from a traditional switch.

It should be noted that GR-303 interface groups work alongside the access switched portion of RT 203. This capability advantageously enables incumbent operators who currently rely on GR-303 to continue operation, in the current mode, without disruption of their business model. Additionally, this capability advantageously allows some small number of other operators to use GR-303 interface groups subject to the same limitations above with respect to unbundling with GR-303.

Access switch 202 is fundamentally a media gateway controller. As such, a variety of transport methodologies can be employed on both the line and trunk sides of RT 203. The line-side technologies might include all forms of DSL, fiber optics, wireless and just POTS. Each of these line technologies might use transport protocols such as TDM, IP, or ATM. The transport protocols are executed at the media gateway (physically, RT 203). Control of the protocols is executed at the media gateway controller (i.e., access switch 202).

Using access switching enables choices of protocol technologies to be associated with line-side technologies on demand. As was discussed in the example of ATM proxy signaling for DSL, access switch 202 makes an ideal location for matching service characteristics to media characteristics, thus insuring the greatest possible flexibility in providing advanced features. Each virtual owner has equal access to resources, thereby fostering both services and competition.

In one implementation, the access device is an NGDLC of the type used as an RT such as RT 203. Furthermore, in this implementation, the call agent is constructed of a library of connection state machines. These state machines utilize common software techniques to track and direct the activity of a particular function. The call control agent includes connection state machines that operate in accordance with an industry standard principal know as “half call state machines.” A connection is constructed from two half call state machines. A telephone call is supported by a half call state machine for a plain old telephone system (POTS) circuit and a half call state machine for a network trunk circuit. The call control agent may, or may not, contain half call state machines for many different types of connections and connections principals such as asynchronous transfer mode (ATM), Internet protocol (IP), and many different variations or adaptations of these communications protocols.

Surrounding the library of connection state machines is an abstraction layer. The abstraction layer interfaces to network hardware. The abstraction layer also is responsible for interfacing with the feature layer of the architecture. The abstraction layer provides a buffering between the exact protocols necessary to operate certain types of network hardware and the general commands that the state machine generates to invoke specific actions. So, for example, the half call state machine for an ATM trunk might give the command “provide silent tone to the connected party” through the abstraction layer. The network control interface on the other side of the abstraction layer might then produce as a result a command in the protocol syntax “snd tn:37,CD” that would be understood at the primitive hardware layer as the exact means of sending silent tone to a trunk party who was “on hold.” The same type of abstraction layer is used between the half call state machines and the feature layer. The call control layer of the network does not know what the exact sequence events will be in a particular feature. The feature server controls the sequential logic of a feature. Thus, the call control agent informs the feature server of actions that invoke features (e.g., hook flash, *69, etc.), and the feature server then provides the sequential logic that create the feature. The role that the call control agent plays for the feature server is detecting state changes at the hardware layer and communicating them, if necessary, to the correct feature server. The type of commands that pass through the feature abstraction layer are “a caller party in conversation has hook flashed.” Depending on the API, the feature server will receive a specific message with the command embedded in the proper syntax. The feature server may respond with a string of commands in the syntax of the specific API. The feature abstraction layer converts these commands into “verb” form, such as “send the caller party dial tone and connect the caller to a tone decoder for dialing.” Thereafter, the connection state machines will transition to the proper state and issue the command to the network hardware layer.

At the actual state machine level, knowledge of what state the systems resources are in is kept. So, for example, if a telephone is off-hook, an instance of a state machine is tracking the progress of that call. The call control state machines have access to the databases that describe what facilities are located where, and what those facilities are allowed to do. In this way, the core state machines can be seen as the traffic cops for the system as well as the translator between the features and the network hardware.

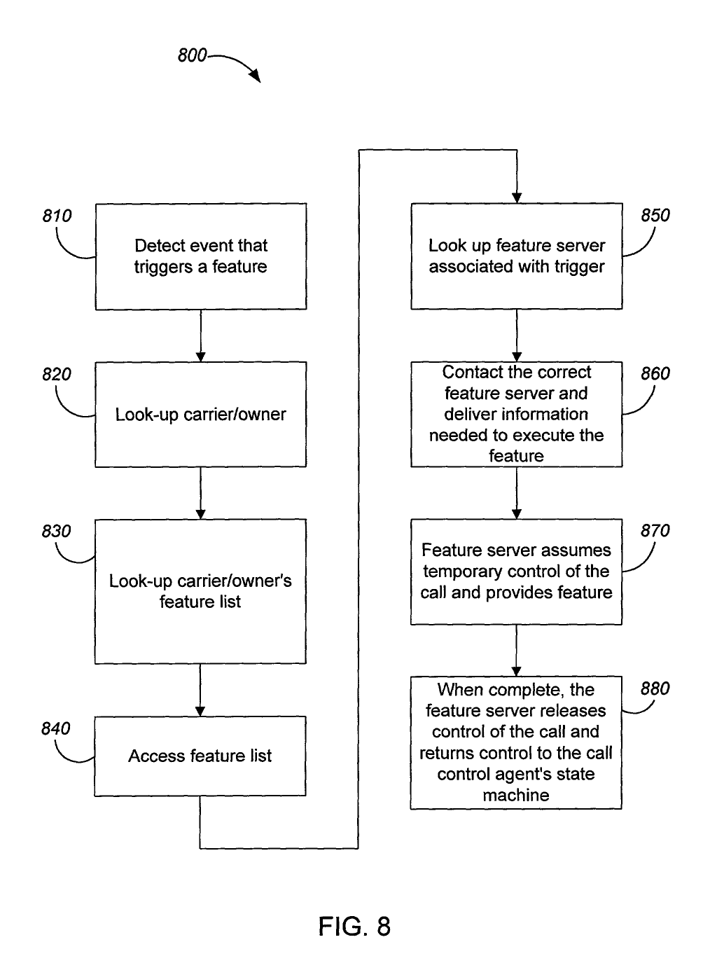

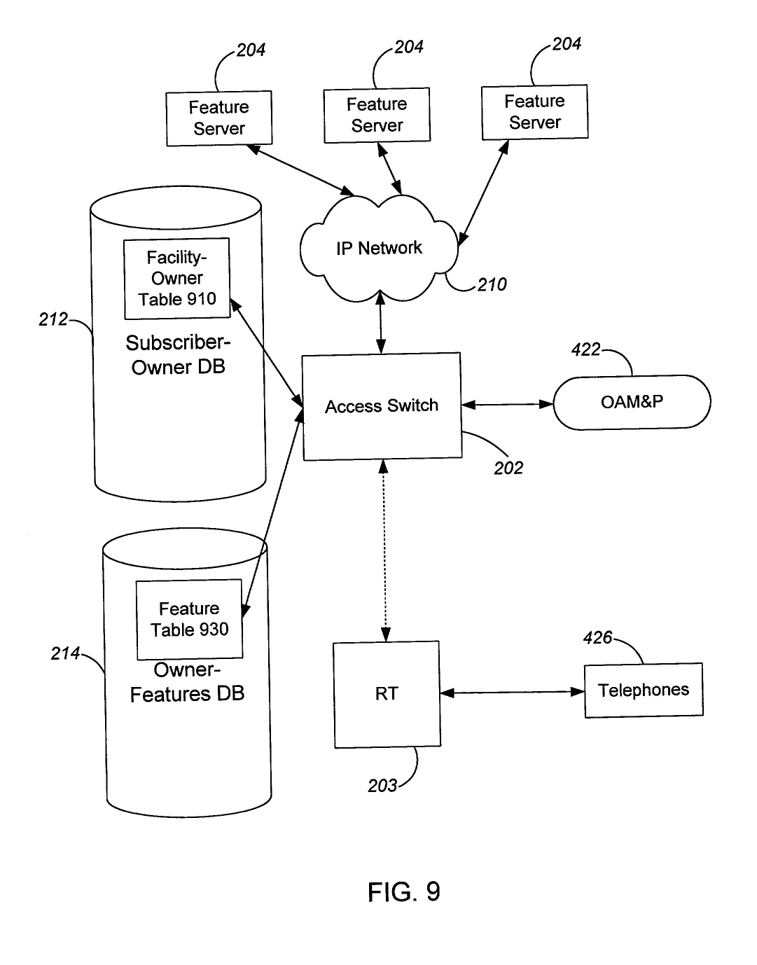

Referring to FIGS. 2, 8, and 9, when a state machine detects an event that would trigger a feature (hook flash during conversation, special dialing sequence, in-conversation dialing, etc.) (810), the state machine accesses a database, such as subscriber-owner database 212, and consults a table, such as table 910, that correlates a user circuit to the virtual owner of that circuit (820). Subscriber-owner database 212 includes a table that lists all of the facility addresses in one column and has the name or reference of the virtual owner in the next column. Next, the state machine uses the virtual owner name or reference value to consult another table, such as table 920, that relates virtual owner names or reference values to a location where the list of features managed by that virtual owner is located (830). By prior arrangement, each virtual owner has built a feature table, such as feature table 930 in owner-feature database 214, in the call control agent that describes the features the owner offers, how those features are invoked and the address of the feature server where those features can be found. After the correct feature table has been found for a given virtual owner (840), the state machine goes to that feature table and looks up the action that is necessary for the given trigger (850). The feature table has a minimum of two columns of information. In the first column is the call action feature that is being used for a trigger. In the second column is the location of the feature server associated with that feature. If a match is detected, the call agent contacts the correct feature server and delivers the facility address, the dialed number address, the call action and the class of service for that facility (860). Feature server 204 then assumes temporary control of the call and guides that call through the necessary steps of the feature sequence (870). When complete, feature server 204 releases control of the call and returns control to the call control agent's state machine (880).

Information that is normally provided by switches to their owners such as call detail recording (CDR) for billing purposes, traffic statistics, alarms and maintenance logs can all be driven from a table, such as table 910, that correlates physical facilities to virtual owners. This gives the virtual owners the ability to bill, configure and maintain their switching facilities as if it were their own while not interfering with the general management of the system by the physical owner.

A single call control agent can connect to, for example, 2000 subscriber circuits. Up to 2000 virtual owners could claim at least one of the subscriber circuits as being one of their subscribers. Each virtual owner could then associate as many features and feature servers with his subscribers as he chooses without any further interaction with the real owner of the physical platform other than to build feature tables, such as feature table 930, that relates call actions to feature servers and to register in tables, such as table 910, that correlate physical facilities to virtual owners.

This same technique applies when used with DSL technology. When supporting DSL, a technique that is described in the ATM Forum standards known as “proxy signaling” is used. Proxy signaling describes a relationship between a subscriber terminal (e.g., telephone, modem, integrated access device (IAD), or computer) and a call control agent. Typically, a subscriber terminal has little knowledge of the network or how to make a connection in the network. This configuration is similar to that of a telephone. A regular telephone has no knowledge of how to do anything but create tones that the call control agent in the network interprets as dialing. It is the call control agent that works as a “proxy signaling agent” for the telephone in that the call control agent is the device that actually makes the network telephone connection. This same concept applies to ATM-based DSL circuits.

The technique proposed by the ATM Forum for proxy signaling for ATM works as follows. A permanent virtual circuit (PVC) is established between the subscriber terminal and the call control agent. The call control agent has access to databases that enable the agent to establish an ATM connection with desired destinations. The call control agent has a PVC connection to a Class 4 ATM edge switch through which it signals on behalf of the subscriber terminal to make the desired connection.

The technique that was described previously applies equally well to the ATM scenario. In this case, the correlation to the feature server would be at the beginning of the call so that the feature server associated with a given service provider would be able to download a menu to the subscriber terminal that would offer features, services and probably other data (e.g., advertising of various sorts). The end user would select a feature or action from the menu and the feature server would inter-work with the call control agent's proxy signaling to establish the desired connection.

In the case of ATM proxy signaling, each of the steps of correlating a circuit to a virtual owner, an owner to a feature table and then a feature table to a feature server would apply as it would during a voice call. The only significant difference would be the way a voice call progresses (off hook, dial tone, dialing, feature) versus the way and ATM proxy call progresses (request for service, download menu, select menu item, and invoke a feature).

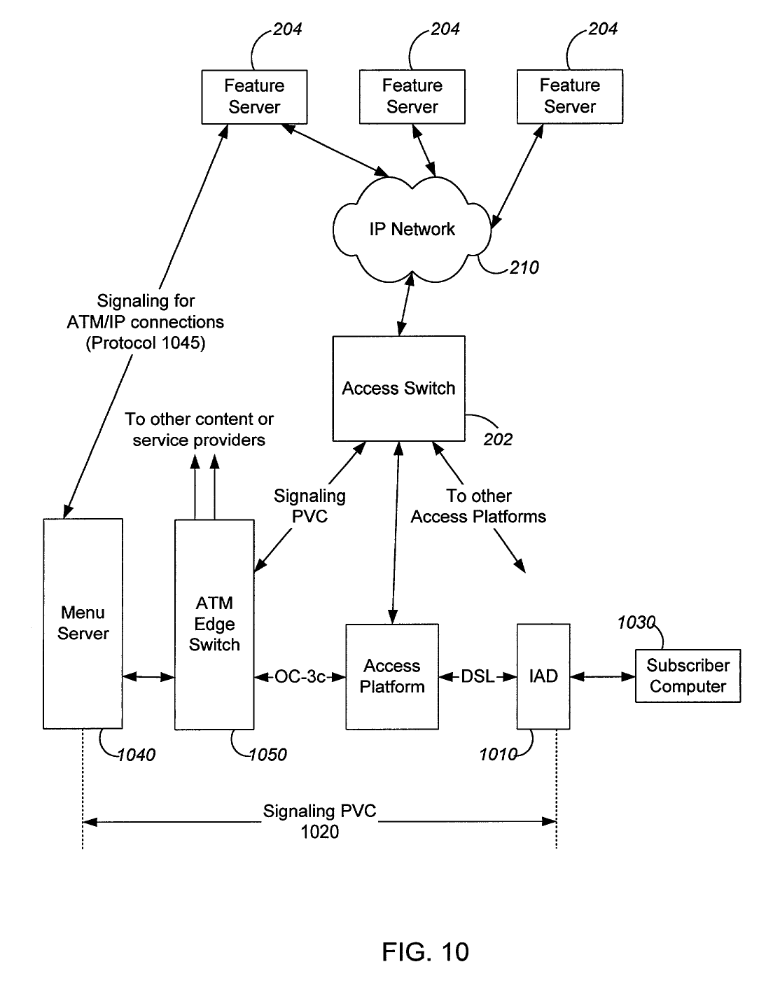

For example, as shown in FIG. 10, for ATM proxy signaling, internet access device (IAD) 1010 signals over a low bandwidth, pre-provisioned signaling PVC 1020 that runs between subscriber 1030 and a service provider's menu server 1040. Menu server 1040 can signal back to access switch 202 using a protocol 1045, such as a layer 3 IP, to establish SVCs, thereby using access switch 202 as a call agent that: (1) oversees the use of OC-3c connections and monitors committed capacity; and (2) signals to ATM switch 1050 to establish SVCs.

A number of embodiments of the invention have been described. Nevertheless, it will be understood that various modifications may be made without departing from the spirit and scope of the invention. Accordingly, other embodiments are within the scope of the following claims.

What is claimed is:

1. A method for sharing a remote terminal, comprising:
providing control intelligence that is separate from service-delivery hardware of a network that includes a remote terminal, wherein the control intelligence controls the operations of the remote terminal; and
time-sharing resources of the remote terminal among competitive local exchange carriers (CLEC), wherein the control intelligence mediates access to the remote terminal, whereby multiple CLECs provide telecommunication services on the remote terminal.

2. The method of claim 1, wherein providing control intelligence from the service-delivery hardware includes providing a computer program including control intelligence to control the routing and switching operations of remote terminals, the computer program being resident on a computer that is remote from the remote terminal.

3. The method of claim 2, further comprising routing voice data from a telephone network to a media gateway for further routing to a packet network when the control intelligence detects a subscriber request to route voice traffic to a packet network.

4. The method of claim 3, wherein routing voice data from a telephone network to a packet network includes routing voice data from a telephone network to a network supporting an asynchronous transfer mode.

5. The method of claim 4, wherein routing voice data from a telephone network to a packet network includes routing voice data from a telephone network to a network supporting an internet protocol.

6. The method of claim 5, further comprising:
providing one or more computers each having one or more programs that provide telecommunication features, wherein the computers are configured to communicate with the control intelligence; and
providing databases that are separate from service-delivery hardware of the network to guide the delivery of telecommunication features, the databases relating a subscriber and the subscriber's respective feature provider, as well as feature providers and telecommunication features offered by each feature provider, wherein the control intelligence causes the delivery of telecommunication features to the subscribers according to the databases;
whereby the system enables multiple feature providers to provide customized telecommunication features to subscribers through the remote terminal.

7. A system for sharing a remote terminal, comprising:
control intelligence to control a remote terminal in a telecommunication network having service-delivery hardware, wherein the control intelligence mediates access to the remote terminal and wherein the control intelligence is separate from the service-delivery hardware; and
databases that are separate from service-delivery hardware of the network to guide the delivery of telecommunication features, the databases relating a subscriber and the subscriber's respective local exchange carrier, as well as local exchange carriers and telecommunication features offered by each local exchange carrier, wherein the control intelligence causes the delivery of telecommunication features to the subscribers according to the databases;
whereby the system enables multiple local exchange carriers to provide service and customized telecommunication features to subscribers through the remote terminal.

8. The system of claim 7 further comprising an access switch configured to communicate with the remote terminal, wherein the control intelligence is a computer program resident on a computer in the access switch.

9. The system of claim 8, wherein the control intelligence controls switching operations of the remote terminal.

10. The system of claim 9, wherein the control intelligence controls routing operations of voice traffic to and from the remote terminal.

11. The system of claim 10, further comprising control intelligence for routing voice traffic from a telephone network to a packet network, wherein the control intelligence causes the remote terminal to route voice traffic to a media gateway connected to the packet network.

12. The system of claim 7, wherein the packet network supports an asynchronous transfer mode.

13. The system of claim 12, wherein the packet network supports an internet protocol.

14. The system of claim 13, further comprising control intelligence for providing digital subscriber line service to a subscriber terminal, wherein the control intelligence causes the access switch to proxy signal for a subscriber terminal to an asynchronous-transfer-mode switch.

15. The system of claim 14, further comprising one or more computers that are remote from the access switch and remote terminals, wherein each computer includes one or more computer programs that provide the telecommunication features, whereby a feature provider customizes the computer programs to provide telecommunication features that the feature provide desires to offer to subscribers.
